(19) United States
(12) Patent Application Publication
(10) Pub. No.: US 2004/0240891 A1
(43) Pub. Date: Dec. 2, 2004

(54) Optical transmission apparatus and optical modulation apparatus

(75) Inventor: Masato Tanaka, Sagamihara-shi (JP)

Correspondence Address: LOUIS WOO, LAW OFFICE OF LOUIS WOO, 717 NORTH FAYETTE STREET, ALEXANDRIA, VA, 22314, US

(73) Assignee: Matsushita Electric Industrial Co., Ltd., Osaka (JP)

(21) Appl. No.: 10/848,372

(22) Filed: May 19, 2004

(30) Foreign Application Priority Data
May 27, 2003 (JP) 2003-149601

(51) Int. Cl. H04B 10/04

(52) U.S. Cl. 398/183

(57) ABSTRACT

In an optical transmission apparatus, the intensity of the output light of a light source is modulated with a low-frequency signal from a low-frequency oscillator. The output light is modulated with an information signal in an external modulator and is then sent to an optical fiber amplifier. A signal synchronous with the low-frequency signal or a signal synchronous with a variation in the level of the output light of the light source modulated with the low-frequency signal is sent to an excitation source of the optical fiber amplifier to control the output power of the excitation source. An erbium doped fiber amplifies the optical signal outputted from the external modulator by multiplexing the optical signal with excitation light from the excitation source.

### BACKGROUND OF THE INVENTION

1. Field of the Invention

The present invention relates to an optical modulation apparatus that suppresses stimulated Brillouin scattering (SBS) which is caused by the non-linearity of an optical fiber in an optical transmission system, and an optical transmission apparatus using the optical modulation apparatus.

2. Description of the Related Art

To transfer optical signals over a long distance in an optical transmission system, the transmission power or the output of an optical amplifier is enhanced in order to compensate for a loss in the transmission path. However, the enhancement of the transmission power or the output of an optical amplifier is limited to such a degree as not to cause stimulated Brillouin scattering. Widening the spectrum of the light source is effective in suppressing the occurrence of stimulated Brillouin scattering. In this case, the laser diode which is the light source is modulated with a low-frequency signal as disclosed in, for example, Japanese Patent Laid-Open Publication No. H10-70514/1998 (see the Abstract and FIG. 1).

The conventional optical transmission system also transfers signals that amplitude-modulated with a low-frequency signal, thereby causing the intersymbol interference that reduces the reception sensitivity.

### SUMMARY OF THE INVENTION

Accordingly, it is an object of the invention to provide an optical modulation apparatus which overcomes the problem of the conventional optical transmission system and suppresses a level variation caused when the light intensity of a light source, and an optical transmission apparatus using the optical modulation apparatus.

To achieve the object, an optical amplifier in an optical transmission apparatus or an optical modulation apparatus located at the preceding stage of the optical transmission apparatus suppresses the level variation of a level-variable optical signal outputted from the optical transmission apparatus or the optical modulation apparatus in order to make the level variation constant.

According to the first aspect of the invention, there is provided an optical transmission apparatus comprising:

a low-frequency signal source;

a light source which is modulated by a low-frequency signal from the low-frequency signal source;

optical modulation means which modulates an output light of the light source with an information signal;

an excitation source whose output power is controlled by a signal synchronous with the low-frequency signal or a signal synchronous with a variation in a level of the output light of the light source modulated with the low-frequency signal; and

optical amplification means which amplifies an optical signal outputted from the optical modulation means by multiplexing the optical signal with an excitation light from the excitation source.

This structure has an advantage of suppressing a change in the intensity of an optical signal by means of an optical amplifier while widening the optical spectrum by modulating the light source with a low-frequency signal.

According to the second aspect of the invention, there is provided an optical transmission apparatus comprising:

a low-frequency signal source;

a plurality of light sources which are modulated by a low-frequency signal from the low-frequency signal source;

a plurality of optical modulation means which respectively modulate individual output lights of the light sources with a plurality of information signals;

an excitation source whose output power is controlled by a signal synchronous with the low-frequency signal or a signal synchronous with a variation in a level of each of the output lights of the light sources modulated with the low-frequency signal;

a multiplexer which performs wavelength multiplexing by multiplexing a plurality of optical signals respectively outputted from the plurality of optical modulation means; and

optical amplification means which amplifies an output optical signal outputted from the multiplexer by multiplexing that output optical signal with an excitation light from the excitation source.

This structure has an advantage of simultaneously suppressing variations in the intensities of wavelength-multiplexed optical signals by means of an optical amplifier while widening the optical spectrum by modulating the optical signals from the light sources with a low-frequency signal.

In the optical transmission apparatus according to the first or the second aspect of the invention, the phase of the signal synchronous with the low-frequency signal or the signal synchronous with the variation in the level of the output light of the light source modulated with the low-frequency signal may be opposite to the phase of the low-frequency signal which modulates the light source.

This structure has an advantage such that a change in the intensity of the optical signal from the light source can be canceled out reliably, thereby ensuring efficient suppression of the change in the intensity of the optical signal.

According to the third aspect of the invention, there is provided an optical modulation apparatus comprising:

a low-frequency signal source;

a light source which is modulated by a low-frequency signal from the low-frequency signal source;

variable attenuation means which changes an envelope with a signal amplitude of an information signal by a signal synchronous with the low-frequency signal or a signal synchronous with a variation in a level of the output light of the light source modulated with the low-frequency signal; and

optical modulation means which modulates an output light of the light source with an optical signal of the variable attenuation means.

This structure has an advantage of suppressing a change in the intensity of an optical signal by the optical modulation means by changing the envelope of an information signal while widening the optical spectrum by modulating the light source with a low-frequency signal.

In the optical modulation apparatus, the phase of the signal synchronous with the low-frequency signal or the signal synchronous with the variation in the level of the output light of the light source modulated with the low-frequency signal may be opposite to the phase of the low-frequency signal which modulates the light source.

This structure has an advantage such that a change in the intensity of the optical signal from the light source can be canceled out reliably, thereby ensuring efficient suppression of the change in the intensity of the optical signal.

### BRIEF DESCRIPTION OF THE DRAWINGS

FIG. 1 is a block diagram of an optical transmission apparatus according to a first embodiment of the invention;

FIG. 2 is a block diagram of an optical transmission apparatus according to a second embodiment of the invention;

FIG. 3 is a block diagram of an optical modulation apparatus according to a third embodiment of the invention; and

FIG. 4 is a signal waveform diagram illustrating the operation of each embodiment of the invention.

### DETAILED DESCRIPTION OF THE PREFERRED EMBODIMENTS

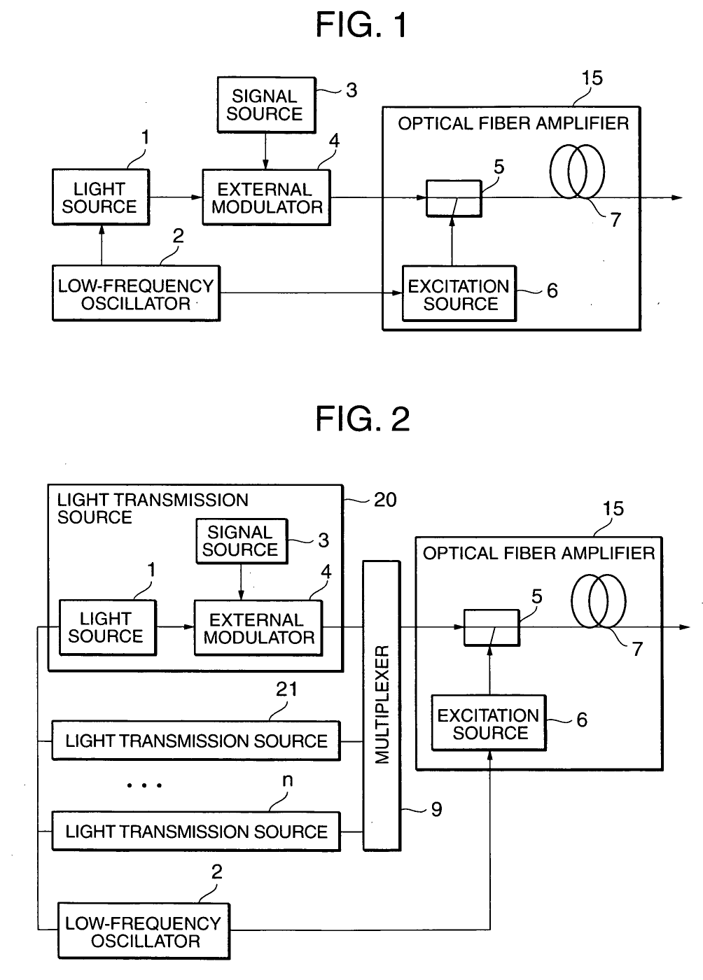

Preferred embodiments of the invention as adapted to an optical transmission apparatus and an optical modulation apparatus are described below with reference to FIGS. 1 to 4.

(First Embodiment)

FIG. 1 is a block diagram of an optical transmission apparatus according to the first embodiment of the invention. The optical transmission apparatus comprises a light source 1, a low-frequency oscillator 2, a signal source 3, an external modulator 4 and an optical fiber amplifier 15. The optical fiber amplifier 15 includes a multiplexer 5, an excitation source 6 and an optical fiber 7 doped with a rare earth element, such as erbium (hereinafter also referred to as “erbium doped fiber”).

As the light intensity of the light source 1 is modulated with a signal outputted from the low-frequency oscillator 2, the optical spectrum is widened. The optical signal is modulated in the external modulator 4 with a signal outputted from the signal source 3. The multiplexer 5 multiplexes the optical signal, modulated in the external modulator 4, with excitation light from the excitation source 6. The resultant, multiplexed optical signal is inputted to the erbium doped fiber 7 to be amplified. The light intensity of the excitation source 6 is modulated with a signal from the low-frequency oscillator 2 in a phase opposite to the phase of the light source 1. As a result, the intensity of the excitation light to be inputted to the erbium doped fiber 7 changes in the opposite phase to the phase of the intensity of the light source 1, thus causing the amplification factor of the erbium doped fiber 7 to change in the opposite phase to the phase of the intensity of the light source 1. This cancels out a variation in the intensity of the optical signal outputted from the erbium doped fiber 7 caused by the low-frequency signal, so that the intensity of the optical signal becomes nearly constant.

The following discusses signal waveforms referring to FIG. 4. When the low-frequency signal changes like a waveform 10, the envelope of the change in the intensity of the optical signal outputted from the optical fiber amplifier 15 can be made nearly constant like a waveform 12 by making a change in the amplification factor of the erbium doped fiber 7, caused by a change in excitation light, like a waveform 11.

(Second Embodiment)

FIG. 2 is a block diagram of an optical transmission apparatus according to the second embodiment of the invention. The optical transmission apparatus comprises a plurality of light transmission sources 20 to n, a low-frequency oscillator 2, an optical fiber amplifier 15, and a multiplexer 9. Each of the light transmission sources 20 to n includes a light source 1, a signal source 3 and an external modulator 4. The optical fiber amplifier 15 includes a multiplexer 5, an excitation source 6 and an erbium doped fiber 7.

Optical signals outputted from the light transmission sources 20 to n are multiplexed by the multiplexer 9 and then inputted to the optical fiber amplifier 15. At this time, low-frequency originated changes in the intensities of the optical signals outputted from the light transmission sources 20 to n are restrained by the optical fiber amplifier 15 as explained in the foregoing description of the first embodiment. The structure of the second embodiment can allow the single optical fiber amplifier 15 to restrain changes in the intensities of the optical signals outputted from the light transmission sources 20 to n.

(Third Embodiment)

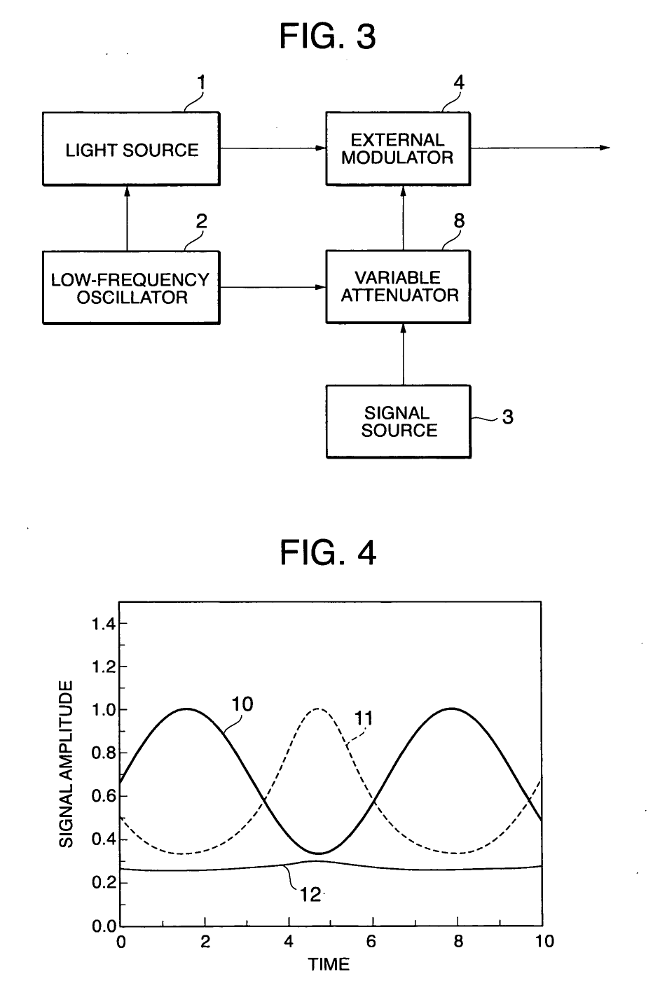

FIG. 3 is a block diagram of an optical modulation apparatus according to the third embodiment of the invention. The optical modulation apparatus comprises a light source 1, a low-frequency oscillator 2, a signal source 3, an external modulator 4 and a variable attenuator 8. As the light intensity of the light source 1 is modulated with a signal outputted from the low-frequency oscillator 2, the optical spectrum is widened. The optical signal is modulated in the external modulator 4 with a signal outputted from the signal source 3. The amplitude of the signal that is applied to the external modulator 4 is modulated by the signal from the low-frequency oscillator 2 in a phase opposite to a change in the intensity of the light source 1. This cancels out a variation in the intensity of the optical signal outputted from the external modulator 4, so that the intensity of the optical signal becomes nearly constant.

The following discusses signal waveforms referring to FIG. 4. When the low-frequency signal changes like the waveform 10, the envelope of a transmission signal to be applied to the external modulator 4 changes like the waveform 11 by making a change in the attenuation factor of the variable attenuator 8 change like the waveform. Accordingly, the envelope of the low-frequency originated change in the intensity of the optical signal outputted from the external modulator 4 can be made nearly constant like the waveform 12.

In the foregoing description of the individual embodiments, the signal which is sent to the light source 1 from the low-frequency oscillator 2 is in the opposite phase to the phase of the signal which is sent to the excitation source 6 or the variable attenuator 8 from the low-frequency oscillator 2. As the signal which is sent to the excitation source 6 or the variable attenuator 8 has only to be synchronous with the low-frequency signal which is sent to the light source 1 from the low-frequency oscillator 2 or synchronous with a variation in the level of the output light of the light source 1 which is modulated with the low-frequency signal, however, the signal to be sent to the excitation source 6 or the variable attenuator 8 should not necessarily be a signal directly obtained from the low-frequency oscillator 2.

As described above, the invention widens the power spectrum of the optical signal outputted from the optical transmission apparatus by modulating the output light of the light source with a low-frequency signal to suppress stimulated Brillouin scattering and can reduce degradation of the reception sensitivity caused by intersymbol interference in the optical reception apparatus when the level of the optical signal changes because the level change is suppressed by the optical amplifier or the external modulator.

1. An optical transmission apparatus comprising:
a low-frequency signal source;
a light source which is modulated by a low-frequency signal from said low-frequency signal source;
optical modulation means which modulates an output light of said light source with an information signal;
an excitation source whose output power is controlled by a signal synchronous with said low-frequency signal or a signal synchronous with a variation in a level of said output light of said light source modulated with said low-frequency signal; and
optical amplification means which amplifies an optical signal outputted from said optical modulation means by multiplexing said optical signal with an excitation light from said excitation source.

2. An optical transmission apparatus comprising:
a low-frequency signal source;
a plurality of light sources which are modulated by a low-frequency signal from said low-frequency signal source;
a plurality of optical modulation means which respectively modulate individual output lights of said light sources with a plurality of information signals;
an excitation source whose output power is controlled by a signal synchronous with said low-frequency signal or a signal synchronous with a variation in a level of each of said output lights of said light sources modulated with said low-frequency signal;
a multiplexer which performs wavelength multiplexing by multiplexing a plurality of optical signals respectively outputted from said plurality of optical modulation means; and
optical amplification means which amplifies an output optical signal outputted from said multiplexer by multiplexing that outputted optical signal with an excitation light from said excitation source.

3. The optical transmission apparatus according to claim 1, wherein a phase of said signal synchronous with said low-frequency signal or said signal synchronous with said variation in said level of said output light of said light source modulated with said low-frequency signal is opposite to a phase of said low-frequency signal which modulates said light source.

4. An optical modulation apparatus comprising:
a low-frequency signal source;
a light source which is modulated by a low-frequency signal from said low-frequency signal source;
variable attenuation means which changes an envelope with a signal amplitude of an information signal by a signal synchronous with said low-frequency signal or a signal synchronous with a variation in a level of said output light of said light source modulated with said low-frequency signal; and
optical modulation means which modulates an output light of said light source with an optical signal of said variable attenuation means.

5. The optical modulation apparatus according to claim 4, wherein a phase of said signal synchronous with said low-frequency signal or said signal synchronous with said variation in said level of said output light of said light source modulated with said low-frequency signal is opposite to a phase of said low-frequency signal which modulates said light source.

6. The optical transmission apparatus according to claim 2, wherein a phase of said signal synchronous with said low-frequency signal or said signal synchronous with said variation in said level of said output light of said light source modulated with said low-frequency signal is opposite to a phase of said low-frequency signal which modulates said light source.
